(19) United States
(12) Patent Application Publication
(10) Pub. No.: US 2012/0063165 A1
(43) Pub. Date: Mar. 15, 2012

(54) LIGHT GUIDE DEVICE AND BACKLIGHT MODULE

(75) Inventors: CHUNG HUNG CHIEN, PING-ZHEN INDUSTRIAL PARK (TW); WEN FENG CHENG, PING-ZHEN INDUSTRIAL PARK (TW)

(73) Assignee: ENTIRE TECHNOLOGY CO., LTD., TAOYUAN COUNTY (TW)

(21) Appl. No.: 12/970,444

(22) Filed: Dec. 16, 2010

(30) Foreign Application Priority Data
Sep. 10, 2010 (TW) 099130752

(51) Int. Cl. F21V 7/22; G02B 6/00

(52) U.S. Cl. 362/607; 362/551

(57) ABSTRACT

A light guide device and a backlight module containing the light guide device thereon are provided. The light guide device comprises a main body and pluralities of microstructures. The main body has refractive index n. A thickness T is defined between the base face and the emitting face of light guide device. Each microstructure comprises a first foundation, a second foundation, an apex, a first reflective face, a second reflective face and a plane face. The microstructure has width P. The first reflective face connects the first foundation and the apex, wherein a first distance L₁ is defined between the first foundation and the apex. The second reflective face connects the second foundation and the apex, wherein a second distance L₂ is defined between the second foundation and the apex. The plane face defines an interval S between the two adjacent microstructures, wherein the equation is satisfied:

$$0.47 < \sqrt{\frac{n * T * {L}_{1}}{S * P} * \sqrt{1 - {( \frac{{P}^{2} + {L}_{1}^{2} - {L}_{2}^{2}}{2 {PL}_{1}} )}^{2}}} < 4.8 .$$

### FIELD OF THE INVENTION

The present invention relates to a light guide device and a backlight module containing the light guide device thereon, particularly to the light guide device and the backlight module with both functions of light ray guiding and diffusion.

### DESCRIPTION OF THE PRIOR ART

In recent years, the traditional Cathode Ray Tube display (CRT display) is gradually replaced by Liquid Crystal Display (LCD). This is mainly because the LCD releases far less radiation than the CRT display, and the cost of LCD also drops significantly in recent years. This is why LCD had come into vogue for utilization in TV or computer display.

Generally, a LCD may comprise a panel and a backlight module. In small size of LCD, a specific configuration of edge-type backlight module is normally used, so as to prevent thicker configuration or higher manufacturing cost. In common, the edge-type backlight module might contain a light guide device and at least one light source. The light source is disposed at side of the light guide device, so that the light ray emitted from the light source may have optical path entering the light guide device from edge, transmitting the light ray inside the light guide device and eventually emitting the light ray toward outside from one face of the light guide device. In this manner, the purpose of the light guide device is to manage the light ray, so as to uniformly disperse light ray and then emit the light ray from one of face of the light guide device, by taking advantage of microstructures or local reflection from reflective dots.

However, the light guide device, in practice, may not achieve sufficient uniform emission, so that a common name of “Dark Belt” which has uneven bright and dark is appeared. Thus it would significantly degrade the experience of using LCD. In this scenario, how to achieve better and more uniform light ray emitted from the light guide device is a critical problem needed to be addressed.

### SUMMARY OF THE INVENTION

The primary object of present invention is to achieve sufficient uniform emission and prevent uneven bright and dark in light guide device or backlight module.

To achieve the foregoing and other objects, a light guide device is provided. The light guide device comprises a main body and pluralities of microstructures. The main body has refractive index n and contains a emitting face, a base face and at least one incident face. The incident face is disposed at one side of emitting face. The base face is disposed corresponding to the emitting face, wherein a thickness T is defined between the base face and the emitting face. The microstructures are disposed on the base face. Each microstructure comprises a first foundation, a second foundation, an apex, a first reflective face, a second reflective face and a plane face. The first foundation and the second foundation define a width P between the first foundation and the second foundation. The first reflective face connects the first foundation and the apex, wherein a first distance L₁ is defined between the first foundation and the apex. The second reflective face connects the second foundation and the apex, wherein a second distance L₂ is defined between the second foundation and the apex. The plane face is disposed between two adjacent microstructures and defines an interval S between the two adjacent microstructures, wherein the equation is satisfied:

0.47<\sqrt{n*T*L₁/S*P*\sqrt{1−(P²+L₁²−L₂²/2PL₁)²}}<4.8.

In the aforementioned light guide device, wherein pluralities of the microstructures are concave or convex.

In the aforementioned light guide device, wherein the further equation is satisfied: 4.5<n*T/S<46.0.

In the aforementioned light guide device, wherein the first distance L₁ of the microstructure is not equal to the second distance L₂ of the same microstructure.

In the aforementioned light guide device, wherein cross section of the first reflective face is a straight line, hyperbola, ellipse or parabola, or cross section of the second reflective face is a straight line, hyperbola, ellipse or parabola.

To achieve the foregoing and other objects, a backlight module is provided. The backlight module comprises at least one light source and a light guide device. The light source is able to project a first optical path and a second optical path. The light guide device may receive the first optical path and the second optical path. The light guide device further comprises a main body and pluralities of microstructures. The main body has refractive index n and contains an emitting face, a base face and at least one incident face. The incident face is disposed at one side of emitting face. The base face is disposed corresponding to the emitting face, wherein a thickness T is defined between the base face and the emitting face. The microstructures are disposed on the base face. Each microstructure comprises a first foundation, a second foundation, an apex, a first reflective face, a second reflective face and a plane face. The first foundation and the second foundation define a width P between the first foundation and the second foundation. The first reflective face connects the first foundation and the apex, wherein a first distance L₁ is defined between the first foundation and the apex. The second reflective face connects the second foundation and the apex, wherein a second distance L₂ is defined between the second foundation and the apex. The plane face is disposed between two adjacent microstructures and defines an interval S between the two adjacent microstructures, wherein light ray may be total reflected toward the main body if the first optical path proceeds to the plane face, or be reflected toward the emitting face if the second optical path proceeds to pluralities of microstructures, and then the following equation is satisfied:

0.47<\sqrt{n*T*L₁/S*P*\sqrt{1−(P²+L₁²−L₂²/2PL₁)²}}<4.8.

In the aforementioned backlight module, wherein the first distance L₁ of the microstructure is not equal to the second distance L₂ of the same microstructure.

In the aforementioned backlight module, wherein cross section of the first reflective face is a straight line, hyperbola, ellipse or parabola, or cross section of the second reflective face is a straight line, hyperbola, ellipse or parabola.

Whereby, the light guide device and backlight module may have configuration characterized and achieve dimensionless, so as to reach the optical results in different shapes or configurations. In this manner, the light guide device and the backlight module may have uniform light emission and optimum optical result without “Dark Belt” any more.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1A is diagram of backlight module and its optical path according to the first embodiment of present invention;

FIG. 1B is diagram of relative optical intensity according to the light guide device of FIG. 1A;

FIG. 1C is diagram of relative optical intensity according to the light guide device in distinct configuration;

FIG. 1D is diagram of optical effect when G=0.47˜4.8, n=1.53 and H/P=0.5;

FIG. 1E is diagram of optical effect when G=0.47˜4.8, T=2 mm and H/P=0.5;

FIG. 1F is diagram of optical effect when G=0.47˜4.8, T=2 mm and n=1.53;

FIG. 2 is diagram of backlight module according to the second embodiment of present invention;

FIG. 3 is diagram of backlight module according to the third embodiment of present invention;

FIG. 4 is diagram of microstructure according to the fourth embodiment of present invention;

FIG. 5 is diagram of microstructure according to the fifth embodiment of present invention;

FIG. 6 is diagram of light guide device according to the sixth embodiment of present invention;

FIG. 7 is diagram of light guide device according to the seventh embodiment of present invention.

### DESCRIPTION OF THE PREFERRED EMBODIMENTS

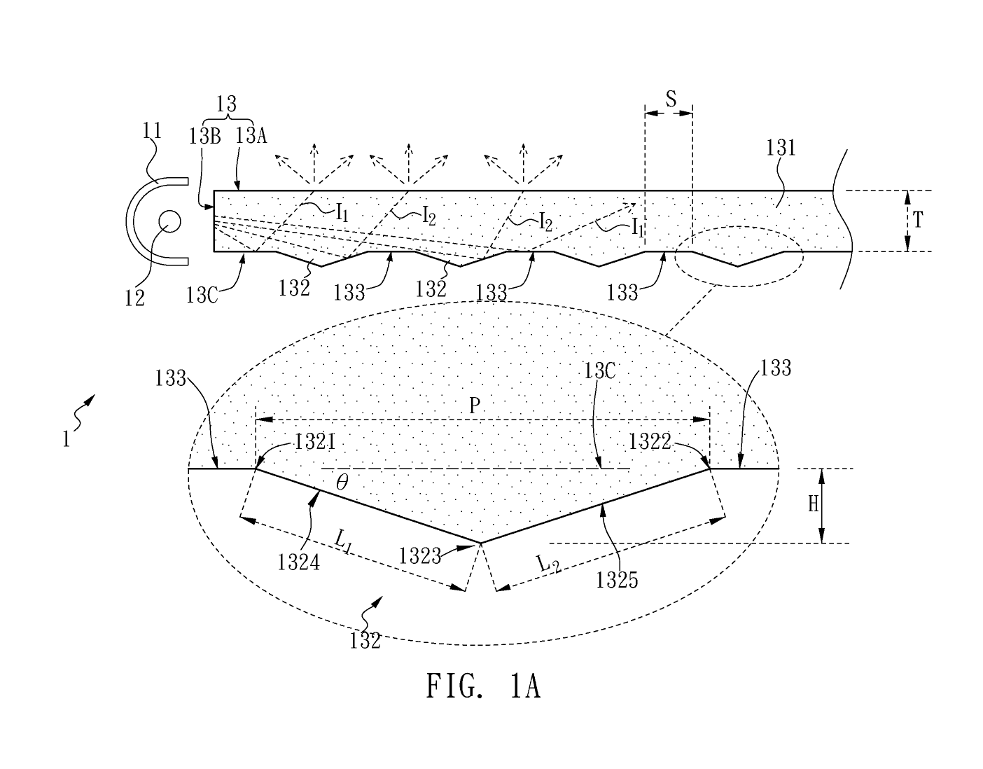

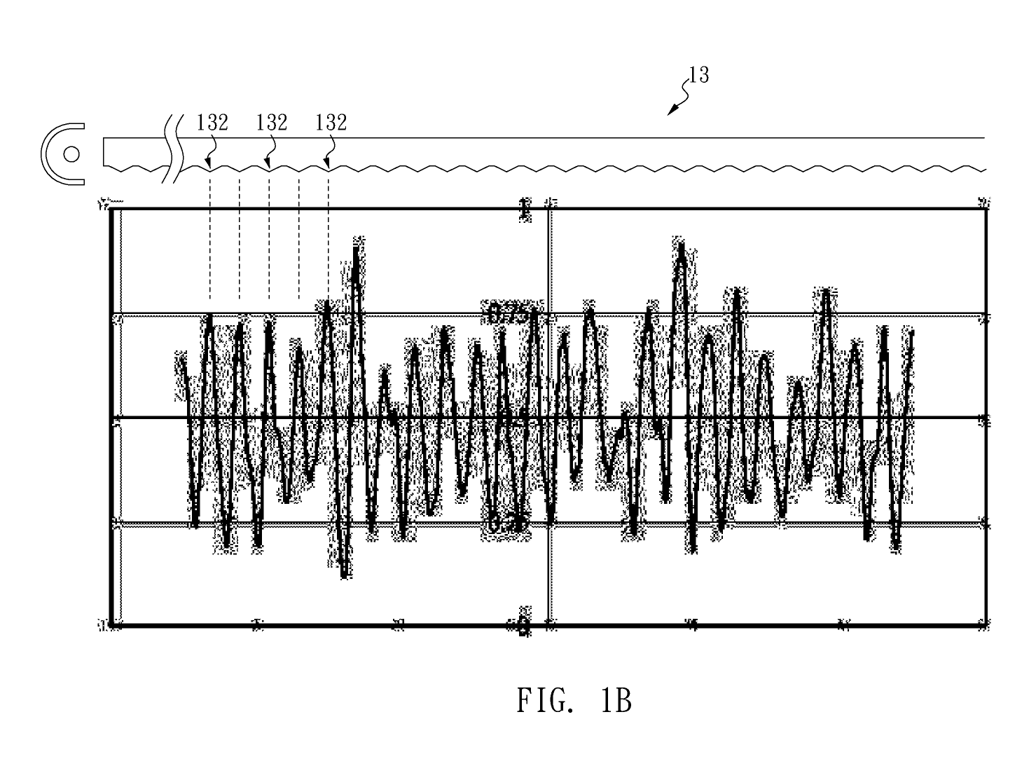

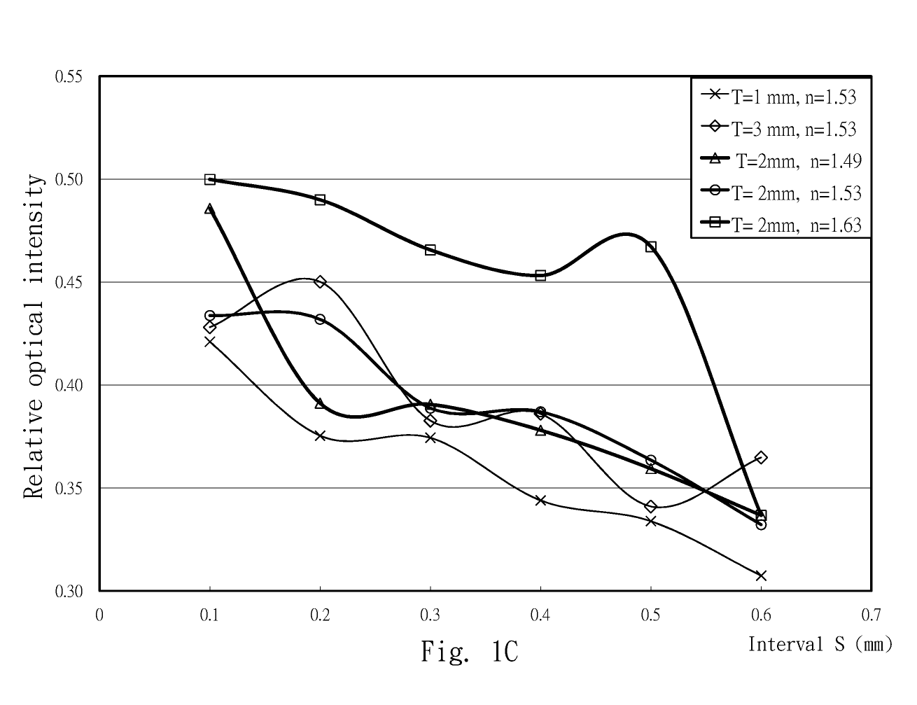

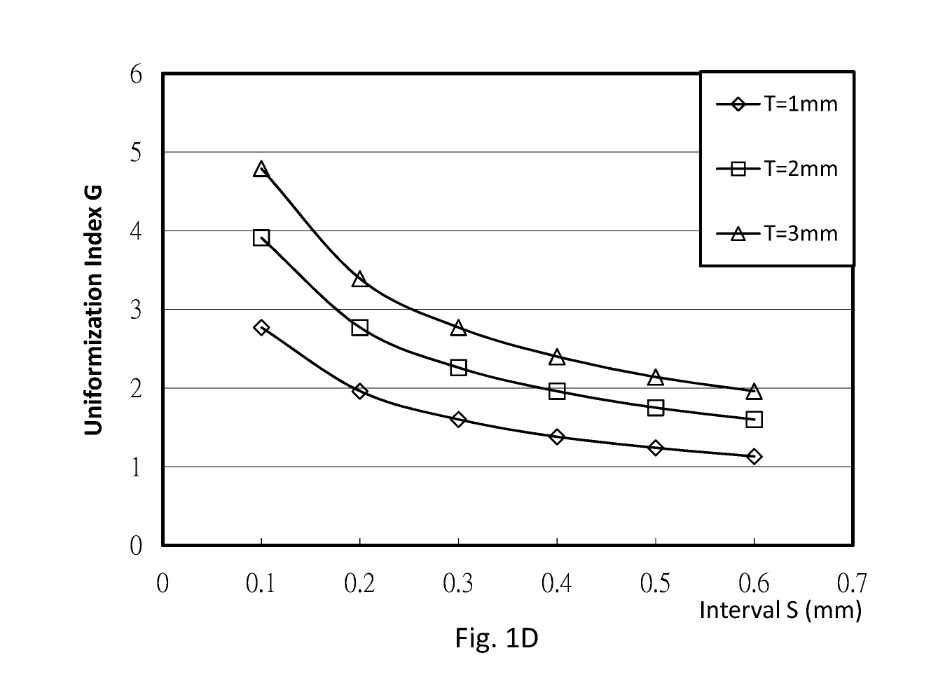

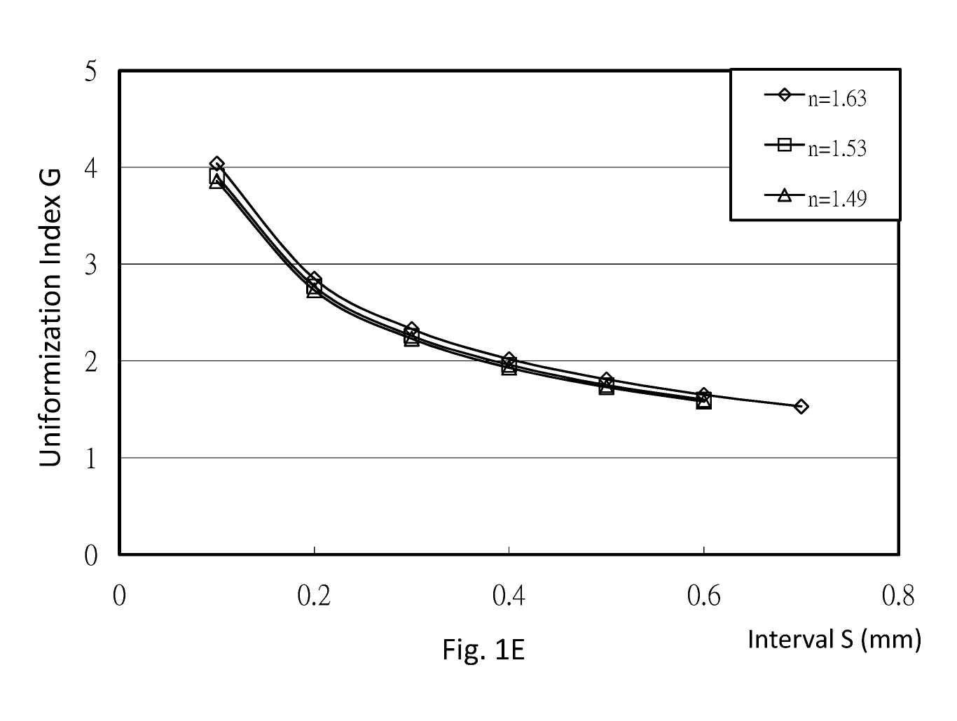

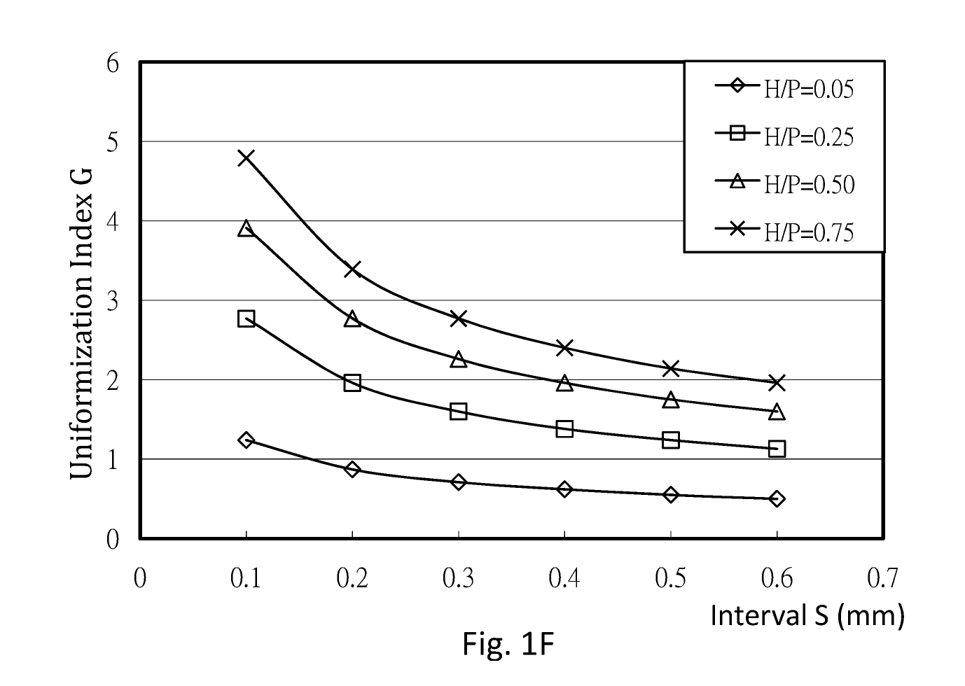

Please refer to FIG. 1A, FIG. 1A is diagram of backlight module and its optical path according to the first embodiment of present invention. As shown in FIG. 1A, a backlight module 1 comprises a light source 12, a cover 11 and a light guide device 13. The light source 12 and the cover 11 are both disposed at outer left side of the light guide device 13. The light source 12 may radiate light ray. The cover 11 is disposed adjacent to the light source 12 and thus may reflect light ray emitted from the light source 12. Then the light ray may be drive to enter the light guide device 13 from left side. The light guide device 13 contains a main body 131, pluralities of plane faces 133 and pluralities of microstructures 132. The main body 131 has refractive index n and contains a emitting face 13A, a base face 13C and a incident face 13B. The microstructures 132 are convex structures disposed on the base face 13C. As shown in enlarged diagram of FIG. 1A, each microstructure 132 is composed of a first foundation 1321, a second foundation 1322, an apex 1323, a first reflective face 1324 and a second reflective face 1325. The material of the light guide device 13 might be Polyethylene Terephthalate (PET), Polycarbonate (PC), Tri-acetyl Cellulose (TAC), Polymethylmethacrylate (PMMA), Methylmethacrylate styrene, Polystyrene (PS), Cyclic Olefin Copolymer (COC), or combination of at least two aforementioned materials. The emitting face 13A is on upper side of the light guide device 13; the incident face 13B is at left side of the light guide device 13; the base face 13C is at lower side of the light guide device 13. Thus the incident face 13B is disposed at left side of the emitting face 13A, and then the base face 13C is corresponded to the emitting face 13A at up and down position. The base face 13C has a thickness T away from the emitting face 13A. The microstructures 132 are disposed on the base face 13C. The distance between the first foundation 1321 and the second foundation 1322 is defined as width P. The first reflective face 1324 connects to the first foundation 1321 and the apex 1323. The range between the first foundation 1321 and the apex 1323 is defined as first distance L₁. The second reflective face 1325 connects to the second foundation 1322 and the apex 1323. The range between the second foundation 1322 and the apex 1323 is defined as second distance L₂. The plane face 133 is disposed between the second foundation 1322 and the first foundation 1321 of another microstructure 132. The cross sectional distance between two microstructures 132 is interval S. Namely, the plane face 133 is the horizontal region between two adjacent microstructures 132. In this embodiment, each microstructure 132 are identical in size and shape, and the interval S of each plane face 133 are also equal.

As shown in FIG. 1A, the light ray radiated from the light source 12 may be expressed as first optical path I₁ and second optical path I₂. After the first optical path I₁ and the second optical path I₂ enter the light guide device 13, the first optical path I₁ may proceed to pluralities of plane faces 133 and then be totally reflected toward the main body 131; meanwhile the second optical path I₂ may proceed to pluralities of microstructures 132 and then be reflected toward the emitting face 13A.

In preferable embodiment, the light source 12 might be Cold Cathode Fluorescent Lamp (CCFL) or Light Emitting Diode (LED). Besides, two light sources 12 and the covers 11 might also be disposed at outer left and outer right of the light guide device 13 respectively according to real situation. In this scenario, left side and right side of the light guide device are both incident face, so that light ray radiated from two light sources may enter the light guide device respectively from left side and right side of the light guide device.

In order to demonstrating the benefit of present invention, several experiments regarding to the light guide device 13 are carried out. Please refer to FIG. 1B, FIG. 1B is diagram of relative optical intensity according to the light guide device of FIG. 1A. In this diagram, horizontal coordinate is fitted to distinct sites of light guide device 13, and then vertical coordinate shows the relative optical intensity of those distinct sites, wherein the relative optical intensity is equal to average intensity divided by maximum intensity. As shown in FIG. 1B, the relative optical intensity of the light guide device 13 is correlated with arrangement of the microstructures 132. It has shown that the microstructures 132 may result in peak intensity. Sadly, if the peak is higher enough relative to the average intensity, the “Dark Belt” sometimes happen.

In order to prevent “Dark Belt” and improve optical quality of backlight module 1, several experiments based on distinct thickness T, distinct refractive index n and distinct interval S are carried out. Please refer to FIG. 1C, FIG. 1C is diagram of relative optical intensity according to the light guide device in distinct configuration. As shown in FIG. 1C, the relative optical intensity is increased when the interval S decreases, no matter the value of the thickness T and refractive index n. If the interval S is smaller, which means that more microstructures 132 may be disposed at the light guide device 13, the amount of the microstructures 132 therefore could be more, so that the “Dark Belt” could be vanished. According to empirical rule, if the value of relative optical intensity is above 0.4, the “Dark Belt” or uneven bright and dark is never appeared.

In this manner, a dimensionless variable, which is deemed characteristic variable combining thickness T, interval S and refractive index n, is achieved: U=n*T/S; wherein the dimensionless variable U is function of thickness T, interval S and refractive index n, so that variable U could be modified by adopting different materials. Besides, after experiment, it is found that the light guide device 13 may achieve better optical diffusion if variable U is between 4.5 and 46.0; namely:

4.5<n*T/S<46 (1)

Except for the configuration of the light guide device 13, the profile or appearance of the microstructure 132 is also important factor which can affect the optical diffusion, e.g. the ratio of depth H and width P of the microstructure 132. As shown in enlarged diagram of FIG. 1A, the depth H is vertical distance between the apex 1323 and the base face 13C. According to empirical rule, it may be achieved better optical diffusion if the ratio of depth H and width P, i.e. value of H/P, is between 0.05 and 0.5. Namely:

0.05<H/P<0.5 (2)

In order to combine the effect of configuration and interval S, the aforementioned equation (1) and (2) are derived as follow;

multiply equation (1) and (2); then

→4.5*0.05<(n*T/S)*(H/P)<46*0.5;

→0.225<(n*T/S)*(L₁*sin θ/P)<23 (3)

wherein symbol θ is angle between the first reflective face 1324 and base face 13C. Besides, a triangle is composed of P, L₁ and L₂, therefore the following equation may be achieved and derived by means of Cosine Law:

L₂²=L₁²+P²−2PL₁ cos θ;

→cos θ=P²+L₁²−L₂²/2PL₁;

→sin θ=\sqrt{1−cos²θ}=\sqrt{1−(P²+L₁²−L₂²/2PL₁)²}; (4)

then put the equation (4) into (3):

→0.225<(n*T/S)*L₁/P\sqrt{1−(P²+L₁²−L₂²/2PL₁)²}<23 (5)

afterward take square root of equation (5):

0.47<\sqrt{n*T*L₁/S*P*\sqrt{1−(P²+L₁²−L₂²/2PL₁)²}}<4.8.

wherein the first distance L₁ and the second distance L₂ of microstructure 132 might be unequal.

Therefore, the optical diffusion of the backlight module 1 may achieve better and more uniform, and then “Dark Belt” of light guide device 13 is happened no more if aforementioned equation (6) is satisfied. In this manner, some mathematical range regarding to optical uniformization of the light guide device 13 and backlight module 1 may be achieved by means of limiting the configuration so as to fit equation (6). It may also have benefit for manufacturing industry to develop better light guide device 13 and backlight module 1, no need to worry about “Dark Belt” phenomenon.

As for the optical result of equation (6) is concerned, an uniformization index G may therefore be defined as function of refractive index n, thickness T, interval S, width P, first distance L₁ and second distance L₂:

G=\sqrt{n*T*L₁/S*P*\sqrt{1−(P²+L₁²−L₂²/2PL₁)²}}; (7)

thus the “Dark Belt” will not happened any more if G=0.47˜4.8.

Moreover, in order to demonstrate the uniformization index G and its dependent variables, the diagram showing the relation between G and interval S is necessary when G=0.47˜4.8. Please refer to FIG. 1D, FIG. 1D is diagram of optical effect when G=0.47˜4.8, n=1.53 and H/P=0.5. As shown in FIG. 1D, the value of uniformization index G increases as the thickness T of light guide device 13 increases. The value of uniformization index G also increases as the interval S decreases while in the same thickness T. Regarding to the uniformization index G, it means that higher G value may have lower chance to cause “Dark Belt.” The experimental result of FIG. 1D has revealed that the value of G is approximating 1.1˜2.9 if thickness T of light guide device 13 is 1 mm, the value of G is approximating 1.5˜3.9 if thickness T of light guide device 13 is 2 mm, and the value of G is approximating 2.0˜4.8 if thickness T of light guide device 13 is 3 mm.

Please refer to FIG. 1E, FIG. 1E is diagram of optical effect when G=0.47˜4.8, T=2 mm and H/P=0.5. As shown in FIG. 1E, the uniformization index G has extremely less variation if distinct materials of light guide device 13, which means different refractive index n, are used. Moreover, the value of G increases as the interval S decreases, which the trend is similar to FIG. 1D. The experimental result has shown that the value of G is approximating 1.5˜3.9 no matter what materials are used in light guide device 13.

Please refer to FIG. 1F, FIG. 1F is diagram of optical effect when G=0.47˜4.8, T=2 mm and n=1.53. As shown in FIG. 1F, the value of G increases as ratio between depth and width, means value of H/P, of light guide device 13 increases. Still, the experiment also shows that the value of G increases as the interval S decreases. Wherein the value of G is approximating 0.5˜1.2 if the value of H/P of light guide device 13 is about 0.05; the value of G is approximating 1.1˜2.8 if the value of H/P is about 0.25; the value of G is approximating 1.6˜4.0 if the value of H/P is about 0.50; the value of G is approximating 2.0˜4.8 if the value of H/P is about 0.75.

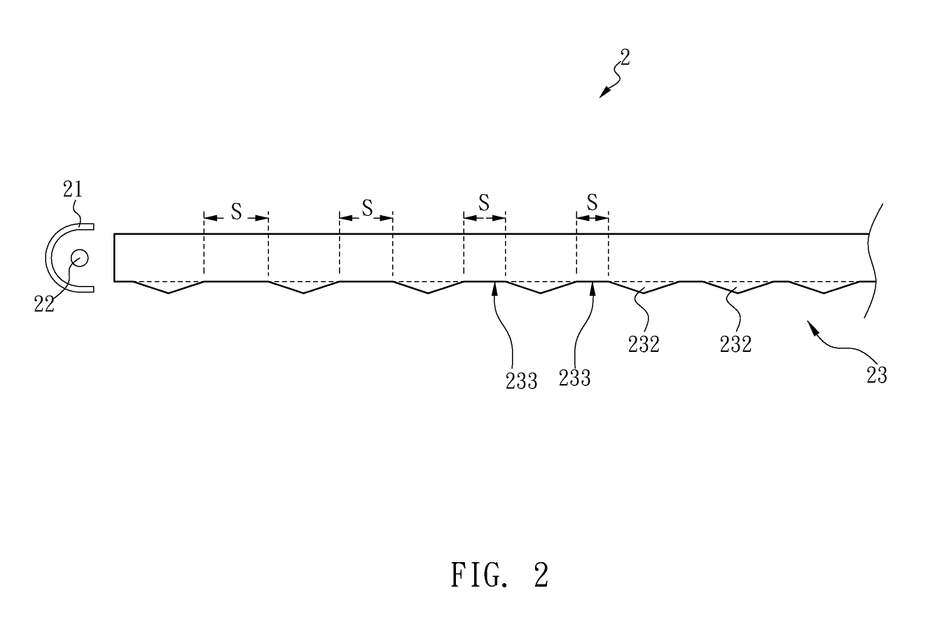

There are some other embodiments remained. Please refer to FIG. 2, FIG. 2 is diagram of backlight module according to the second embodiment of present invention. As shown in FIG. 2 the backlight module 2 comprises a light source 22, a cover 21 and a light guide device 23. In this embodiment, similar configuration is addressed no more. Pluralities of microstructures 232 are identical obtuse isosceles triangles in cross sectional view. Each interval S, which locates between two adjacent microstructures 232 and represents the horizontal distance of the plane face 233, are unequal. Namely, each interval S in the right is smaller than the interval S in the left. The reason is apparently that the site near light source 22 has dense light ray and then needs larger area of plane face 233 to reflect, so as to deliver more light ray to the site away from the light source 22; in this manner, the light ray emitted from upper surface of the light guide device 23 is therefore able to be uniform and even.

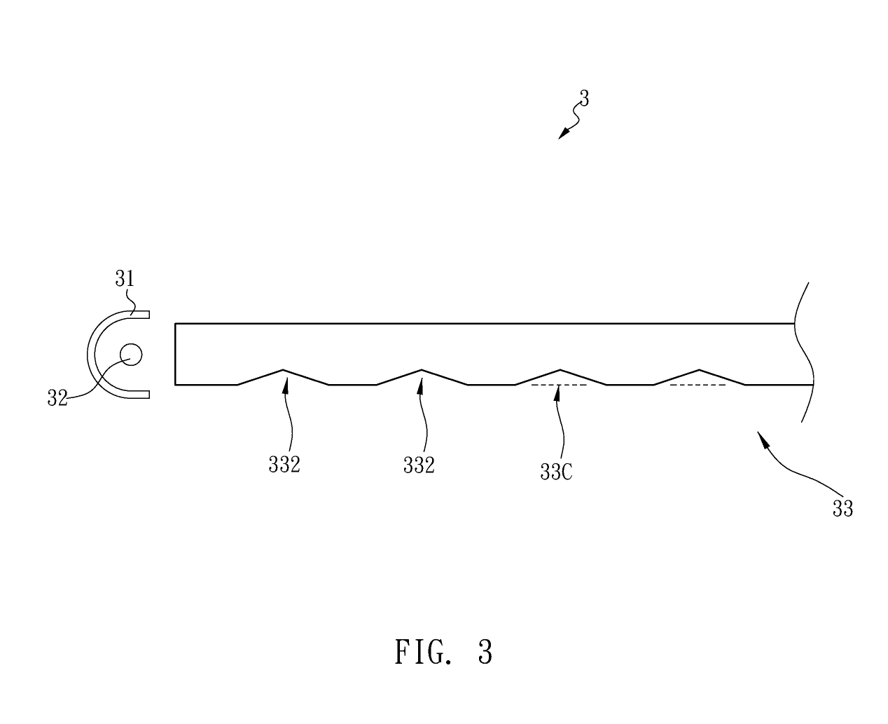

Please refer to FIG. 3, FIG. 3 is diagram of backlight module according to the third embodiment of present invention. As shown in FIG. 3, the backlight module 3 comprises a light source 32, a cover 31 and a light guide device 33. In this embodiment, pluralities of microstructures 332 are concave and disposed at the base face 33C. Therefore the microstructures 332 could reflect light ray toward right side of the light guide device 33.

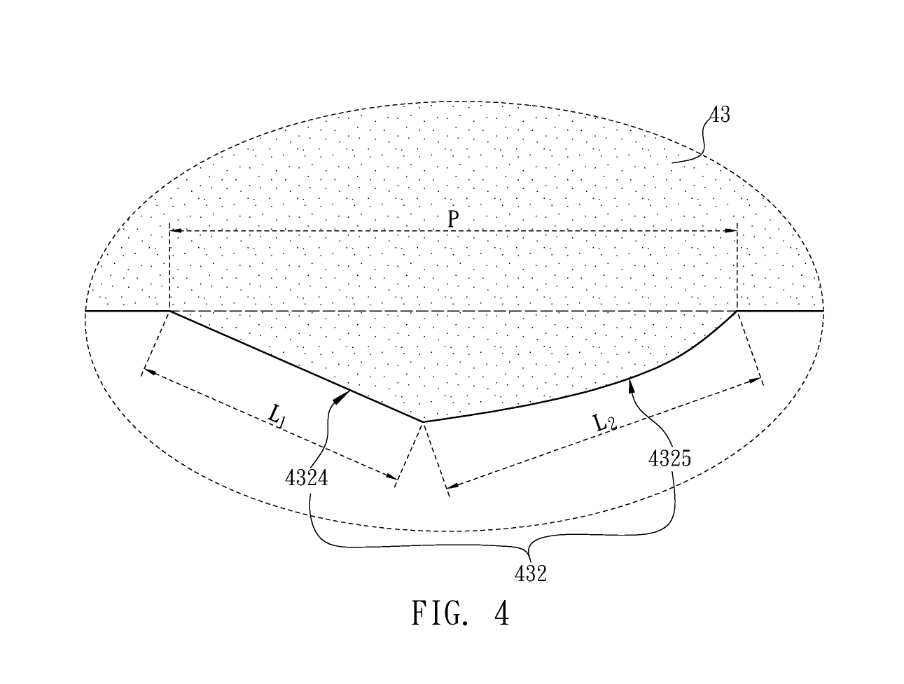

Please refer to FIG. 4, FIG. 4 is diagram of microstructure according to the fourth embodiment of present invention. As shown in FIG. 4, the first reflective face 4324 of light guide device 43 is plane, thus the cross sectional view of the first reflective face 4324 present a straight line.

However, the second reflective face 4325 of the light guide device 43 is a protruded curve, thus the cross sectional view of the second reflective face 4325 may present hyperbola, ellipse or parabola. In this manner, the light guide device 43 might have better transmission for light ray by means of the first reflective face 4324 and second reflective face 4325 of the microstructure 432.

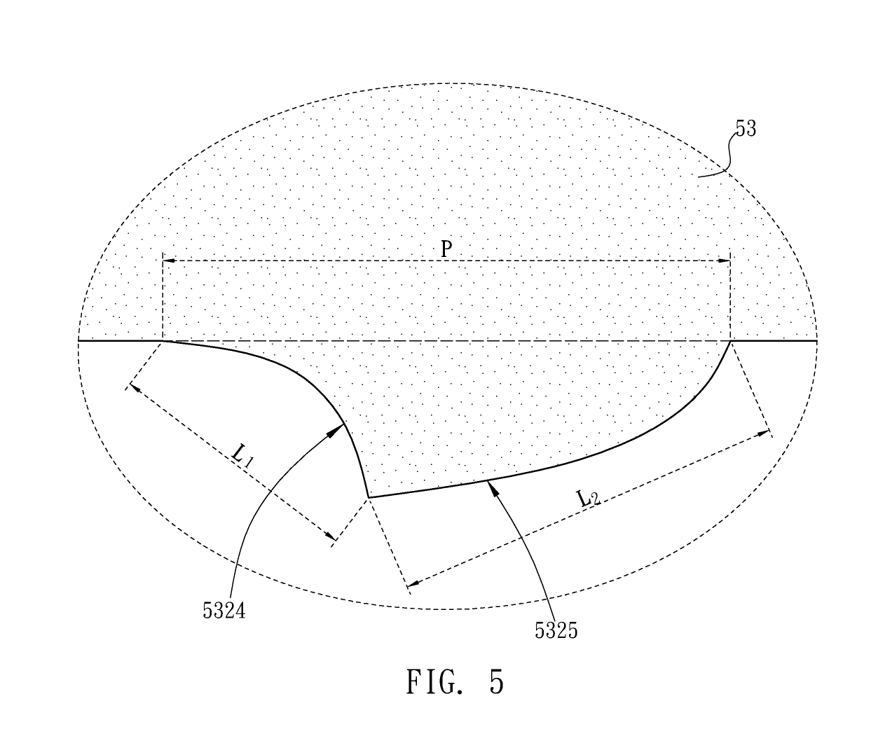

Please refer to FIG. 5, FIG. 5 is diagram of microstructure according to the fifth embodiment of present invention. As shown in FIG. 5, the first reflective face 5324 of light guide device 53 is concave surface, and the second reflective face 5325 is protruded surface. In this manner, similar result as demonstrated before has also achieved.

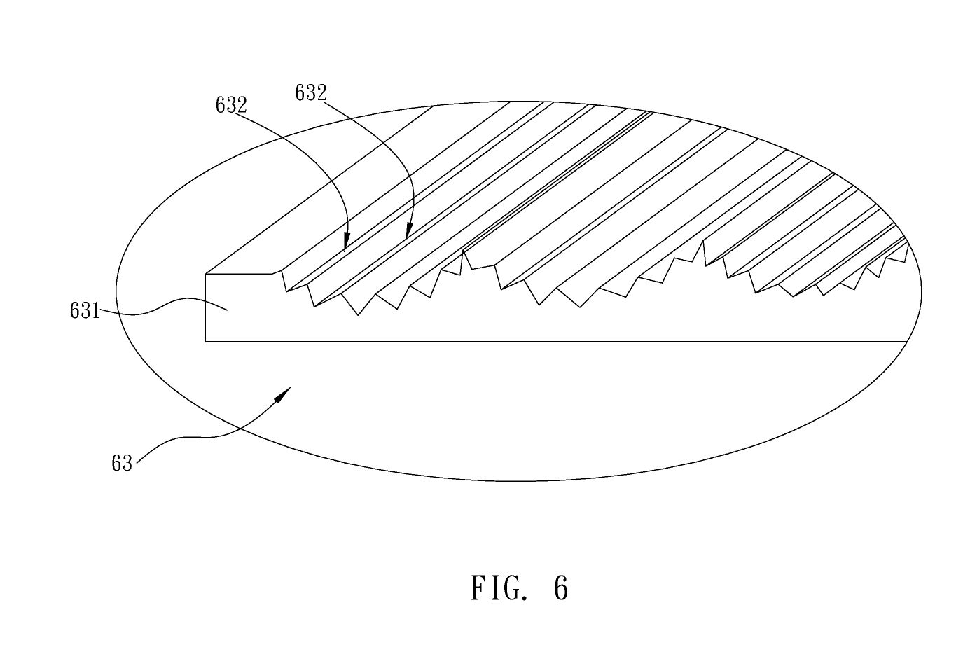

Please refer to FIG. 6, FIG. 6 is diagram of light guide device according to the sixth embodiment of present invention. As shown in FIG. 6, the light guide device 63 comprises pluralities of microstructures 632, wherein these microstructures 632 are triangle-prism columns and arranged at different altitude of the main body 631. In preferred embodiment, the ups and downs of the microstructures 632 are periodic.

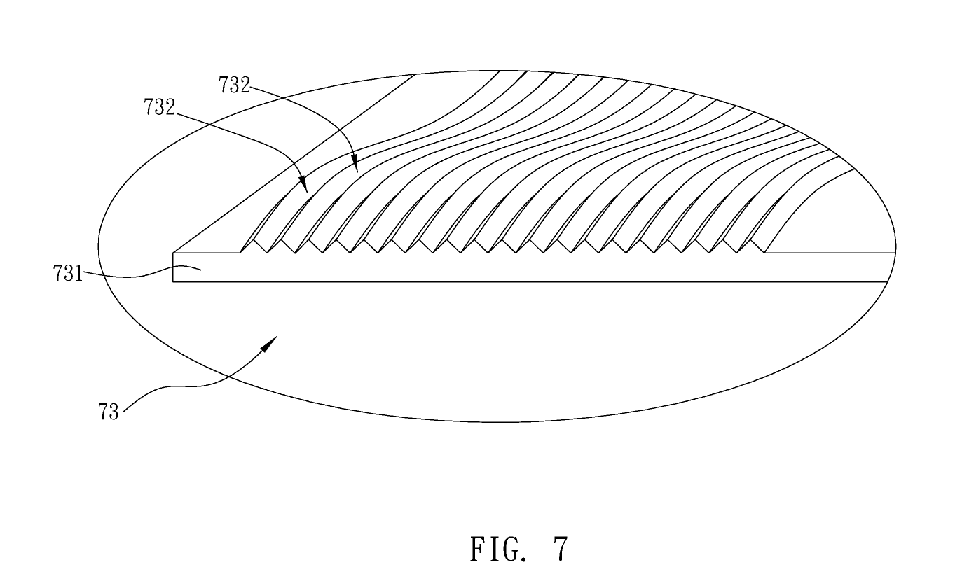

Please refer to FIG. 7, FIG. 7 is diagram of light guide device according to the seventh embodiment of present invention. As shown in FIG. 7, the light guide device 73 comprises pluralities of microstructures 732, wherein these microstructures 732 are horizontally arranged at the same altitude of the main body 731 and present snake shape.

Summarily, the light guide device and backlight module may have configuration characterized and achieve dimensionless, so as to reach the optical results in different shapes or configurations. As addressed before, the light guide device may have uniform light emission and optimum optical result without “Dark Belt,” just only if the light guide device or the microstructures satisfy equation (6). Thus it is extremely convenient for LCD industries to design better light guide device and backlight module.

While certain exemplary embodiments have been described and shown in the accompanying drawings, it is to be understood that such embodiments are merely illustrative of and not restrictive on the broad invention, and that this invention is not be limited to the specific constructions and arrangements shown and described, since various other modifications may occur to those ordinarily skilled in the art.

I claim:

1. A light guide device, comprising:
a main body having refractive index n and containing a emitting face, a base face and at least one incident face, the incident face disposed at one side of emitting face, the base face disposed corresponding to the emitting face, wherein a thickness T is defined between the base face and the emitting face;
pluralities of microstructures disposed on the base face and each microstructure comprising:
a first foundation and a second foundation defining a width P between the first foundation and the second foundation;
an apex;
a first reflective face connecting the first foundation and the apex, wherein a first distance L₁ is defined between the first foundation and the apex;
a second reflective face connecting the second foundation and the apex, wherein a second distance L₂ is defined between the second foundation and the apex;
a plane face disposed between two adjacent microstructures and defining a interval S between the two adjacent microstructures, wherein the equation is satisfied:
$$0.47 < \sqrt{\frac{n * T * {L}_{1}}{S * P} * \sqrt{1 - {( \frac{{P}^{2} + {L}_{1}^{2} - {L}_{2}^{2}}{2 {PL}_{1}} )}^{2}}} < 4.8 .$$

2. The light guide device as claim 1, wherein pluralities of the microstructures are concave or convex.

3. The light guide device as claim 1, wherein further equation is satisfied: 4.5<n*T/S<46.0.

4. The light guide device as claim 1, wherein the first distance L₁ of the microstructure is not equal to the second distance L₂ of the same microstructure.

5. The light guide device as claim 1, wherein cross section of the first reflective face is a straight line, hyperbola, ellipse or parabola, or cross section of the second reflective face is a straight line, hyperbola, ellipse or parabola.

6. A backlight module, comprising:
at least one light source being able to project a first optical path and a second optical path;
a light guide device receiving the first optical path and the second optical path, the light guide device further containing:
a main body having refractive index n and containing a emitting face, a base face and at least one incident face, the incident face disposed at one side of emitting face, the base face disposed corresponding to the emitting face, wherein a thickness T is defined between the base face and the emitting face;
pluralities of microstructures disposed on the base face and each microstructure comprising:
a first foundation and a second foundation defining a width P between the first foundation and the second foundation;
an apex;
a first reflective face connecting the first foundation and the apex, wherein a first distance L₁ is defined between the first foundation and the apex;
a second reflective face connecting the second foundation and the apex, wherein a second distance L₂ is defined between the second foundation and the apex;
a plane face disposed between two adjacent microstructures and defining a interval S between the two adjacent microstructures;
wherein light ray may be total reflected toward the main body if the first optical path proceeds to the plane face, or be reflected toward the emitting face if the second optical path proceeds to pluralities of microstructures, and then the following equation is satisfied:
$$0.47 < \sqrt{\frac{n * T * {L}_{1}}{S * P} * \sqrt{1 - {( \frac{{P}^{2} + {L}_{1}^{2} - {L}_{2}^{2}}{2 {PL}_{1}} )}^{2}}} < 4.8 .$$

7. The backlight module as claim 6, wherein the first distance L₁ of the microstructure is not equal to the second distance L₂ of the same microstructure.

8. The backlight module as claim 6, wherein cross section of the first reflective face is a straight line, hyperbola, ellipse or parabola, or cross section of the second reflective face is a straight line, hyperbola, ellipse or parabola.
